(19) United States
(12) Patent Application Publication
(10) Pub. No.: US 2019/0156401 A1
(43) Pub. Date: May 23, 2019

(54) Method and System for Placing and Processing an Order in a Restaurant or Bar Establishment

(71) Applicant: ROBERT R. SMALE, Mossley, Ontario (CA)

(72) Inventor: ROBERT R. SMALE, Mossley, Ontario (CA)

(21) Appl. No.: 15/759,572

(22) PCT Filed: Sep. 15, 2016
(86) PCT No.: PCT/CA2016/000235

§ 371 Date: Mar. 13, 2018

Related U.S. Application Data
(60) Provisional application No. 62/218,729, filed on Sep. 15, 2015.

(51) Int. Cl. G06Q 30/06; G06Q 20/32; G06Q 50/12; G06K 7/14

(52) U.S. Cl. CPC G06Q 30/0641; G06K 7/1417; G06Q 50/12; G06Q 20/3224

(57) ABSTRACT

A method of placing and processing an order in a restaurant or bar establishment, using a mobile electronic device, by scanning a scannable code located at a specific location in the establishment that contains machine readable information identifying the establishment and a the specific location. The mobile electronic device communicates with a server over a network to receive a menu and transmit an order, and checks for the presence of a local signal broadcast at the establishment. The establishment then receives the order, prepares the order, and delivers the order to the specific location.

### FIELD OF THE INVENTION

The present invention relates to electronic ordering methods and systems and, in particular, to electronic ordering methods and systems using a mobile electronic device to interact with a scannable code, located, for example, in a restaurant or bar establishment.

### BACKGROUND

Mobile electronic devices, such as smartphones, have become ubiquitous among consumers. Service industries, including the restaurant and bar industries, are actively exploring new ways to interact with customers and potential customers electronically, for example, through social media and smartphone applications, or “apps”. Competition in these industries puts pressure on businesses to embrace the latest in social trends, including technological trends.

Examples of the successful implementation of online ordering of food and beverages in the restaurant and bar industry include online ordering of food for pick-up or delivery through a business' own website, or a third party website. The number of people ordering food online is growing and many take-out and delivery businesses are responding to take advantage of the trend. However, the ordering process for “dine-in” customers at a restaurant or bar establishment has remained largely unchanged.

Accordingly, there is a demand for new and innovative ways for establishments to interact with their customers in the ordering process.

### SUMMARY OF THE INVENTION

A method, according to the present invention, of placing and processing an order, comprises the steps of scanning a scannable code that contains machine readable information identifying an establishment and a specific location at the establishment using a mobile electronic device;

transmitting the information identifying the establishment from the mobile electronic device to a server;

transmitting a menu corresponding to the establishment from the server to the mobile electronic device;

selecting at least one menu item from the menu on the mobile electronic device to create an order;

broadcasting a local signal at the establishment from a transmitter;

receiving the local signal at the establishment on the mobile electronic device;

comparing the local signal to a database of a plurality of local signals corresponding to a plurality of establishments to verify that the local signal matches the local signal in the database corresponding to the establishment;

transmitting the order and the information identifying the specific location from the mobile electronic device to the server;

transmitting the order and the information identifying the specific location from the server to a computer at the establishment;

preparing the at least one menu item to complete the order; and

delivering the completed order to the specific location.

### DESCRIPTION OF THE INVENTION

A method and system, according to the present invention, permits a customer sitting at a table in a restaurant or bar establishment to place an order, using a mobile electronic device, such as a smartphone. The order is then transmitted to the establishment, or a waitperson/server assigned to the table, to be filled.

The customer is seated at a table in the establishment. At each table is a scannable code, such as a third generation encrypted or non-encrypted quick response code, or “QR code”, that contains machine readable information identifying the establishment and the table. The scannable code may also contain an embedded numeric or alpha-numeric security code. Preferably, the scannable code is located on a sticker or label that is attached directly to the table. The sticker may also display other information, such as wireless network login information for a free wireless internet connection in the establishment. The scannable code may also or instead be proximately located on or near the table, for example, on a menu holder or other display item on the table. Although an optically scannable code, such as a QR code, is preferred, other types of scannable codes may be used, such as a small electronic device configured for near-field communication, a radio-frequency identification (RFID) tag, or other short-range communication signals.

While the present invention is described with reference to the scannable code being located on a table, alternatively, the scannable code may be located on the floor, on a post, or on another fixture, for example, in an area of an establishment without tables. This may be preferable in certain types of establishments, such as dance clubs, where there are few tables and a significant area of the establishment is set up as standing room only. In this case, the scannable code would identify a designated area of the establishment, rather than a particular table.

The mobile electronic device is configured to recognize and scan a scannable code located on the table. Preferably, the mobile electronic device is a smartphone that is connected to the internet and configured to recognize the scannable code, for example, by way of a camera and a QR code recognition software application. The mobile electronic device runs a software application that recognizes the scannable code and communicates with a remote server, for example, over the internet. The mobile electronic device also displays information from the server to the customer and receives input from the customer, for example, by way of a touch-screen. While the present invention is described with reference to a server, a plurality of servers may be used, which may communicate with one another or operate independently.

The customer uses the mobile electronic device to scan the scannable code at the table. Preferably, the customer will do this by using a camera on their mobile electronic device to take a photograph of a sticker on the table, including the scannable code. The mobile electronic device then communicates with the remote server, preferably over the internet and transmits the establishment and table information from the scannable code to the server. The server uses the establishment information to look up a menu in a database of menus, corresponding to the establishment in which the customer is seated. This permits the server to store different menus from a plurality of establishments and to select the appropriate menu in response to requests from a plurality of customers, seated in different establishments. The server then transmits the menu corresponding to the establishment back to the mobile electronic device, which receives and displays the menu to the customer.

The server may also store menus in any number of languages, to permit provision of the appropriate menu to the customer in their desired language. Each menu item may be inputted by the establishment in one or more languages and translated, for example, by machine translation, into any number of other languages. The customer may pre-select a preferred language in which to receive information from the server, such as menu information. The establishment may also pre-select a preferred language in which to receive information from the server, which may be the same or different from the language selected by any particular customer. The customer may then make menu selections, or otherwise interact with the server, in their selected language and the selected menu items may be transmitted to the establishment in the language selected by the establishment.

The customer uses the mobile electronic device to make a selection from the menu and create an order, which is transmitted to the server. The server receives the customer's order and transmits it, along with the table information from the scannable code, to a computer at the establishment. Preferably, the computer is a tablet or workstation computer located at the establishment, which may also be used by the establishment to process manually entered orders and communicate with a tablet or workstation computer in the kitchen or elsewhere in the establishment. The computer receives the customer's order and table information and accepts the order, transmitting a confirmation to the server, indicating that their order has been accepted by the establishment. Optionally, the order may be held pending a manual review by the establishment staff, before the order is accepted and a confirmation is transmitted to the server. This may be useful, for example, where order restrictions are required by government regulation. The server receives the confirmation from the establishment and provides the customer with a confirmation that their order has been accepted by the establishment. The establishment then prepares the order and delivers it to the customer at the table.

Often, more than one bartender may be preparing beverages from a single order tracking system. In this case, the order may be placed in a queue with other orders, which may be displayed on one or more screens behind the bar to alert the bartenders of the pending orders. One of the bartenders may select an order from the queue, which will then be displayed as “in-progress”, or otherwise distinguished from the other, unselected, pending orders, so that another bartender does not begin preparing beverages for the same order.

When the bartender completes the order, he or she may select the “in-progress” order and designate it as “ready for pick-up”. An alert may be sent to one or more electronic devices carried by members of the wait staff, or displayed on one or more screens to alert members of the wait staff of orders that have been designated “ready for pick-up”. The order may then be picked up from the bar and delivered to the customer, based on their location.

The customer may also be given the option to include a personal identifier, such as a name or photograph, with their order, which will be transmitted to the establishment, via the server, along with their order. This may be done separately for each order, or may be set up as part of a user profile stored by the software application running on the customer's mobile electronic device. A personal identifier is particularly useful in establishments where customers may not be seated at a particular table, but rather standing in a crowded area with numerous other customers. Alternatively, the customer's user profile may be stored on the server, rather than on the user's mobile electronic device.

The mobile electronic device may also be configured to receive a local signal broadcast from a transmitter located within the establishment, in order to verify that the customer is located within the establishment when placing an order. This may be done by matching the local signal to a corresponding record in a database of signals used for identifying particular establishments. The database of local signals may be stored on the mobile electronic device, for example, as part of the software application, or it may be stored on the server. Preferably, the transmitter is a wireless router, or a second wireless router if the establishment provides wireless Internet to its customers, which broadcasts a short-range signal, such as a Wi-Fi signal, that identifies the establishment. The local signal is localized to approximately the physical boundaries of the establishment. Alternatively, the local signal may extend beyond the physical boundaries of the establishment, but may be configured to locate or otherwise determine whether the mobile device is physically located within the establishment. The mobile electronic device is configured to communicate with the server only when it receives the local signal, so that orders are only placed when the customer is actually inside the establishment. Alternatively, the mobile electronic device may be permitted to communicate with the server, but not be permitted to place an order at the establishment, unless it is located within the physical boundaries of the establishment.

Where the scannable code also contains an embedded numeric or apha-numeric security code, it may be used as an additional security feature to verify that the customer is located within the establishment when placing the order. This may be done similarly to the local signals, as described above, by matching the embedded security code to a corresponding record in a database of security codes used for identifying particular establishments or particular tables. The embedded security code is recognized by the mobile electronic device, along with the establishment and table information in the scannable code, and transmitted to the server for verification.

The mobile electronic device and the local signal may also be configured to create a pre-determined area around the establishment or venue, such as a garden party, outdoor patio, or a wedding, known as a “geo-fence”. The size and shape of the geo-fenced area may be selected as desired by the operator of the establishment. For larger areas, the signal may be broadcast simultaneously by multiple transmitters, such as wireless routers, to expand the coverage area. Alternatively, a plurality of different signals may be broadcast from a plurality of transmitters, for example, to identify and verify when a customer is located on each floor of a multi-level building.

By way of example, in operation, an establishment owner creates an account with a service provider who operates the server, maintains the menu database, and provides the scannable codes for the establishment owner to place on the tables in the establishment. The establishment owner defines the menu that will be presented to the customers and sets the prices, all of which is stored in the menu database. A customer downloads a software application to a mobile electronic device, such as a smartphone, for recognizing the scannable code, transmitting and receiving information from the server, displaying the menu to the customer, and receiving the customer's menu selections.

The customer enters the establishment, sits at a table, and uses an internet-connected smartphone to scan the scannable code on the table. The scannable code is recognized and read by the software application, which then directs the smartphone to contact the server. The software application then retrieves and display the menu of the restaurant in which the customer is seated. The customer selects one or more menu items on the smartphone and transmits the order to the server, along with the table information so that the customer's order can be matched with the table and delivered accordingly. Before transmitting the order, the software application may check for the presence of a local signal being broadcast in the establishment to verify that the customer is physically located within the establishment.

The server receives the order and table information from the customer's smartphone and transmits it to a computer in the establishment. The bartender reads the order and accepts it. The computer then transmits the acceptance to the server, which transmits a confirmation to the customer, indicating their order has been accepted by the establishment. The bartender then completes the order, which is delivered to the customer at the table.

The software application may also include payment functionality to receive payment from the customer for their order and transfer funds to the establishment. This may be accomplished by various known methods of electronic payment, such as by credit card, PayPal™, or other electronic payment service provider. The customer's payment may be pre-approved, prior to transmitting the order to the establishment for acceptance and the transaction completed, only upon receipt of confirmation of the order from the establishment.

Optionally, the software application may permit the customer to send a message to the computer in the establishment. The software application may provide a number of pre-determined message options, for example requesting the bill or alerting the wait staff to a medical emergency. Alternatively or additionally, the software application may permit the customer to send a customized message using a standard text messaging interface. The message is transmitted, along with the table information, to the server and from the server to the computer in the establishment.

Although the present invention has been described primarily with reference to preparing and delivering beverage orders at a restaurant or bar, the invention may also be used in other types of food and/or beverage operations and venues. For example, a food truck may make use of the electronic ordering method of the present invention, to collect orders along with a personal identifier, as described above, and process payment for the order. This is useful for food trucks where limited space inside the food truck is available for staff and food preparation equipment. Eliminating the space and equipment required for a staff member to take orders and process payments, frees up that space for additional food preparation/storage. In operation, a customer uses their smartphone to scan a scannable code on the side of the food truck and place their order, as described above. The staff of the food truck then prepares the order and uses the personal identifier (eg. name and photograph) to deliver the order to the correct customer waiting near the food truck.

The forgoing description has set out detail of the present invention, however, the disclosure is to be understood as illustrative of the preferred embodiments and changes may be made without departing from the scope of the invention set out in the following claims.

1. A method of placing and processing an order, comprising the steps of:
scanning a scannable code that contains machine readable information identifying an establishment and a specific location at the establishment using a mobile electronic device;
transmitting the information identifying the establishment from the mobile electronic device to a server;
transmitting a menu corresponding to the establishment from the server to the mobile electronic device;
selecting at least one menu item from the menu on the mobile electronic device to create an order;
broadcasting a local signal at the establishment from a transmitter;
receiving the local signal at the establishment on the mobile electronic device;
comparing the local signal to a database of a plurality of local signals corresponding to a plurality of establishments to verify that the local signal matches the local signal in the database corresponding to the establishment;
transmitting the order and the information identifying the specific location from the mobile electronic device to the server;
transmitting the order and the information identifying the specific location from the server to a computer at the establishment;
preparing the at least one menu item to complete the order; and
delivering the completed order to the specific location.

2. The method of claim 1, wherein, before preparing the at least one menu item to complete the order, the method further comprises the steps of:
accepting the order;
transmitting a confirmation that the order has been accepted from the computer at the establishment to the server; and
transmitting the confirmation from the server to the mobile electronic device.

3. The method of claim 2, wherein, before accepting the order, the method further comprises the step of manually reviewing the order.

4. The method of claim 1, wherein:
the menu is transmitted from the server to the mobile electronic device in a first language;
the at least one menu item is selected to create an order in the first language; and
the order is transmitted from the server to the computer at the establishment in a second language.

5. The method of claim 1, wherein the scannable code further contains a machine readable security code.

6. The method of claim 1, further comprising the steps of providing a personal identifier and transmitting the personal identifier along with the information identifying the specific location.

7. The method of claim 6, wherein the personal identifier is a photograph.

8. The method of claim 1, wherein, before preparing the at least one menu item to complete the order, the method further comprises the steps of:
placing the order in a queue of unselected orders on the computer at the establishment;
selecting the order from the queue; and
distinguishing the selected order from the unselected orders in the queue.

9. The method of claim 1, further comprising the steps of:
transmitting a message along with the information identifying the specific location from the mobile electronic device to the server;
transmitting the message and the information identifying the specific location from the server to the computer at the establishment.

10. The method of claim 1, wherein the specific location is a table at the establishment.

11. The method of claim 10, wherein the scannable code is located on the table.

12. The method of claim 1, wherein the specific location is a designated area at the establishment.

13. The method of claim 12, wherein the scannable code is located in the designated area.

14. The method of claim 1, wherein the scannable code is a quick response code.

15. The method of claim 1, wherein the scannable code is a radio frequency identification tag.

16. The method of claim 1, wherein the scannable code is an electronic device configured for near-field communication.
